(19) United States
(12) Patent Application Publication
(10) Pub. No.: US 2026/0107867 A1
(43) Pub. Date: Apr. 23, 2026

(54) AGRICULTURAL MACHINE WITH MACHINE SEGMENTS THAT CAN BE SWIVELED RELATIVE TO EACH OTHER

(71) Applicant: Maschinenfabrik Bernard Krone GmbH & Co. KG, Spelle (DE)

(72) Inventors: MARTIN BOLSMANN, Andervenne (DE); FRANK AHLMER, Westerkappeln (DE); MARKUS ESTER, Beesten (DE); MICHAEL BUDDENDICK, Ahaus (DE)

(21) Appl. No.: 19/353,671

(22) Filed: Oct. 9, 2025

(30) Foreign Application Priority Data
Oct. 9, 2024 (DE) 102024129138.9

(51) Int. Cl. A01B 73/04

(52) U.S. Cl. CPC A01B 73/044

(57) ABSTRACT

The invention relates to an agricultural machine. It comprises a first machine segment and a second machine segment which is pivotably mounted relative to the first machine segment about a segment pivot axis. The machine also comprises a transfer device which is designed to pivot the second machine segment about the segment pivot axis from a segment working position into a segment transport position, which has at least one actuator arranged so as to be pivotable about an actuator segment pivot axis relative to the first machine segment and which has at least one transmission element which is mounted on the actuator so as to be pivotable about an actuator transmission pivot axis spaced from the segment pivot axis and is arranged on the second machine segment. According to the invention, the transmission element is mounted on the second machine segment so as to be pivotable about a transmission segment pivot axis, and the transfer device has a pivot limiting device which is designed to limit the pivoting mobility of the transmission element about the transmission segment pivot axis in such a way that the transmission segment pivot axis is spaced from the actuator pivot plane.

The invention relates to an agricultural machine. The agricultural machine comprises a first machine segment and a second machine segment. The second machine segment is mounted so that it can pivot relative to the first machine segment about a segment pivot axis. The agricultural machine comprises a transfer device. The transfer device is designed to pivot the second machine segment about the segment pivot axis from a segment working position into a segment transport position. The transfer device has at least one actuator which is arranged to be pivotable relative to the first machine segment about an actuator segment pivot axis. The transfer device has at least one transmission element. The transmission element is mounted on the actuator so that it can pivot about an actuator transmission pivot axis. The actuator transmission pivot axis is spaced from the segment pivot axis. The actuator transmission pivot axis is arranged with the actuator segment pivot axis in an actuator pivot plane. The transmission element is arranged on the second machine segment.

Such agricultural machines are well known. The machine segments are usually used to process agricultural crops or to cultivate the soil of agricultural fields. A first known machine of this type has exactly one transmission element which is immovably arranged on the second machine segment. It protrudes upwards from the second machine segment in such a way that the actuator can engage the transmission element above the second machine segment in the segment working position of the second machine segment. A second known machine of the generic type has, in addition to the transmission element described above, a further transmission element between the actuator and the first machine segment. The known machines are disadvantageous due to the space required by the transfer device, in particular the transmission element in the segment transport position of the second machine segment, wherein the space required impairs the construction of the machine segments, in particular the first machine segment. The impairment is particularly great if the second machine segment can be pivoted by a large angle relative to the first machine segment from the segment working position to the segment transport position. In the first machine, the transmission element in the segment transport position protrudes from the second machine segment in particular directly in the direction of the first machine segment and occupies a recess in the first machine segment.

The object of the present invention is to provide a generic agricultural machine which avoids the disadvantage described above and enables a reliable and as extensive as possible pivoting of the second machine segment while maintaining the greatest possible design freedom with regard to the first machine segment.

For this purpose, an agricultural machine is created, comprising a first machine segment, a second machine segment which is pivotably mounted relative to the first machine segment about a segment pivot axis, and a transfer device,
which is designed to pivot the second machine segment about the segment pivot axis from a segment working position into a segment transport position,
which has at least one actuator arranged pivotably about an actuator segment pivot axis relative to the first machine segment and which has at least one transmission element which is mounted on the actuator so as to be pivotable about an actuator transmission pivot axis which is spaced apart from the segment pivot axis and which is arranged with the actuator segment pivot axis in an actuator pivot plane, and which is arranged on the second machine segment.

According to the invention, the object is achieved in that the transmission element is mounted on the second machine segment so as to be pivotable about a transmission segment pivot axis, and the transfer device has a pivot limiting device which is designed to limit the pivoting mobility of the transmission element about the transmission segment pivot axis in such a way that the transmission segment pivot axis is spaced from the actuator pivot plane.

The pivotable mounting of the transmission element allows a variation of the orientation of the transmission element relative to the second machine segment during the pivoting of the second machine segment relative to the first machine segment from the segment working position to the segment transport position. The pivot limiting device is designed to limit, i.e. at least to block on one side, the pivoting mobility during the pivoting of the second machine segment. The pivot limiting device limits the pivoting mobility in particular insofar as a force acts on the transmission element which exceeds the forces transmitted to the transmission element by the actuator and the second machine segment. The pivot limiting device limits the pivoting mobility of the transmission element during operation of the transfer device at least in phases, i.e. at least for part of the time required for pivoting the second machine segment from the segment working position into the segment transport position, and/or at least part of the angular range by which the second machine segment is pivoted from the segment working position into the segment transport position. The pivoting mobility of the transmission element, controlled by the pivot limiting device, allows its disadvantageous installation space requirement to be reduced without having to limit the angular range or the reliability of the transfer device.

The agricultural machine is in particular a harvesting machine, such as a front attachment for a forage harvester designed to harvest maize, or the combination of the forage harvester and the front attachment. If the machine at least comprises the attachment, each machine segment in particular has at least one cutting element for cutting plants to be harvested and at least one conveying element, preferably a conveyor chain circulating around deflection elements of the machine segment during operation, for conveying the cut plants. However, the invention also provides its advantages to other agricultural machines, such as cultivators or seed drills. The agricultural machine according to the invention is characterized in particular by the possibility of folding its machine segments in such a way that the working width which the machine has in use is greater than a transport width which the machine may and has during road travel. In particular, the second machine segment can be pivoted from the segment working position to the segment transport position relative to the first machine segment in order to reduce the width of the machine. In the segment transport position, the second machine segment is in particular at least partially further away from a ground plane than in the segment working position and/or than the first machine segment. The agricultural machine or forage harvester stands on the ground level during operation, particularly with wheels.

The segment working position and the segment transport position of the second machine segment are characterized by its positioning relative to the first machine segment. The first machine segment is preferably immovable or pivotable relative to a machine frame of the machine. Preferably, the first machine segment is arranged in the segment working position of the second machine segment at least partially between a longitudinal center plane of the machine and the second machine segment. The construction of the machine according to the invention described above and below is also possible if the first machine segment and the second machine segment are swapped. Preferably, the agricultural machine has a third machine segment which is arranged mirror-symmetrically to the second machine segment and/or at least two machine segment units which each comprise at least one first and at least one second machine segment.

The axes described above and/or below are to be understood in particular as axes in the geometric sense. The described pivot axes are in particular aligned parallel to each other. The planes described below are to be understood particularly as such in the geometric sense.

In the segment working position of the second machine segment, the machine segments are arranged in particular such that they adjoin one another in a transverse direction perpendicular to the direction of travel. The axes preferably run at least essentially in one direction of travel. The machine segments preferably have a smaller distance from the ground level than the transfer device, at least in the segment working position of the second machine segment.

The actuator is in particular a hydraulic cylinder. In particular, the actuator is mounted on the first machine segment so that it can pivot about the actuator segment pivot axis. As an alternative to the mounting described above, the agricultural machine may comprise a hydraulic cylinder which is itself not pivotably mounted relative to the first machine segment, but which is pivotably connected to an element which in turn is pivotably connected to the transmission element and is thus to be regarded as an actuator within the meaning of claim 1.

The pivot limiting device provides selective pivoting mobility of the transmission element about the transmission segment pivot axis, i.e. relative to the second machine segment. By limiting the pivoting mobility, a deflection of a force generated by the actuator and transmitted between the actuator segment pivot axis and the transmission segment pivot axis is created via the actuator transmission pivot axis. Depending on the geometric design of the transmission element, it creates a significant lever arm between the actuator transmission pivot axis and the segment pivot axis, at least during part of the pivoting of the second machine segment from the segment working position to the segment transport position, which allows a reduction of the force to be generated by the actuator. A pivoting movement of the transmission element relative to the actuator changes at least the extent of the deflection of the force via the actuator transmission pivot axis and in particular allows a selective avoidance of the deflection.

Preferably, the pivot limiting device is designed to limit the pivoting mobility of the transmission element about the transmission segment pivot axis depending on the pivoting position of the second machine segment relative to the first machine segment and/or to the actuator. The freedom of pivoting movement of the transmission element about the transmission segment pivot axis, i.e. relative to the second machine segment, given when pivoting the second machine segment, conversely preferably depends on its orientation/pivot angle relative to the first machine segment and/or to the actuator. The limitation of the pivoting mobility, that is to say in particular a maximum pivoting angle permitted by the pivot limiting device, preferably varies automatically, in particular in a stepped or continuous manner, during the pivoting of the second machine segment from the segment working position into the segment transport position. Alternatively, the limit can be varied manually. By varying the limitation, an approach of the transmission segment pivot axis to the actuator pivot plane is achieved, particularly during the pivoting of the second machine segment. The variation is preferably carried out purely mechanically. Preferably, no further actuator is necessary for varying the limitation, particularly preferably for the entire transfer of the second machine segment from the segment working position to the segment transport position. The preferably automatic dependence of the limitation of the pivoting mobility of the transmission element on the pivoting position of the second machine segment allows reliable exploitation of the advantages of the inventive design of the machine. The actuator pivoting plane moves in particular with the pivoting of the second machine segment relative to the first machine segment.

The pivot limiting device is preferably designed to limit the pivoting mobility of the transmission element about the transmission segment pivot axis in such a way that a first angle by which the second machine segment is to be pivoted from the segment working position into the segment transport position relative to the first machine segment exceeds a second angle by which the transmission element is to be pivoted to pivot the second machine segment from the segment working position into the segment transport position relative to the first machine segment. Particularly preferably, the first angle is at least twice as large, in particular at least three times as large, as the second angle. This design of the transfer device allows particularly favorable ratios of the forces acting from the transmission element and on the transmission element to be achieved, which allow a particularly extensive pivoting mobility of the second machine segment relative to the first machine segment. In addition, the disadvantageous space requirement of the transmission element is kept particularly small.

Preferably, the transfer device is designed such that the transfer segment pivot axis is moved through an auxiliary plane in which the actuator segment pivot axis and the segment pivot axis lie when the second machine segment is pivoted from the segment working position into the segment transport position. In particular, in contrast, the actuator transmission pivot axis is preferably not moved through the auxiliary plane during the aforementioned pivoting of the second machine segment. Preferably, the transfer device is designed such that the second machine segment can be pivoted by more than 90°, particularly preferably by more than 135°, in particular by 180°, from the segment working position into the segment transport position. The transfer device is designed in particular in such a way that a weight force of the second machine segment during its pivoting from the segment working position into the segment transport position, with a suitable arrangement of the machine on the ground level, in phases causes a torque in a first pivoting direction about the segment pivot axis and in phases causes a torque in a second pivoting direction about the segment pivot axis opposite to the first pivoting direction.

Preferably, the pivot limiting device is designed to limit the pivoting mobility of the transmission element about the transmission segment pivot axis in such a way that the transmission segment pivot axis is kept at a distance from the actuator pivot plane at least in the segment working position. The pivot limiting device is furthermore designed in particular such that the transmission segment pivot axis is kept continuously spaced from the actuator pivot plane for a first phase of the pivoting of the second machine segment beginning in the segment working position when pivoting the second machine segment from the segment working position into the segment transport position. In particular, the first phase continues until the second machine segment has reached a center position relative to the first machine segment. Until then, the transmission element remains stationary relative to the second machine segment and/or the transmission segment pivot axis preferably continuously approaches the actuator pivot plane. In particular, the transmission segment pivot axis is moved through the auxiliary plane in this first phase. In the center position, the transmission segment pivot axis preferably has its minimum distance from the actuator pivot plane or is arranged in the actuator pivot plane. Alternatively, the above applies inversely such that the transmission segment pivot axis is kept at a distance from the actuator pivot plane at least in the segment transport position, this limits the first phase, etc.

The transfer device of the machine according to the invention is in particular free of a link mounted in an articulated manner between the actuator and/or the transmission element and the first machine segment. This saves considerable space and weight.

The pivot limiting device preferably has a first stop. The first stop has a first stop partner and a second stop partner and is designed such that the stop partners are in contact in the segment working position of the second machine segment to limit the pivoting mobility of the transmission element about the actuator transmission pivot axis and/or are released from one another when the second machine segment is pivoted from the segment working position into the segment transport position. During the first phases mentioned above, the stop partners of the first stop preferably remain in contact and pivot relative to each other. For this purpose, the two stop partners preferably form a friction bearing. The separation of the mentioned stop partners from each other preferably takes place in the center position. The first stop thus releases the pivoting mobility of the transmission element around the transmission segment pivot axis before the second machine segment reaches the segment transport position. The described function of the first stop is independent of the specific geometric position of the stop partners. The first stop enables the above-described selective limitation of the pivoting mobility of the transmission element in a technically simple manner. The first stop represents a structurally simple solution to achieve the essential purpose of the invention.

In particular, the first stop partner is immovable relative to the actuator, relative to at least a part of the transmission element and/or to the first or second machine segment. Particularly preferably, the first stop partner of the first stop is formed by the transmission element. Alternatively or additionally, the second stop partner of the first stop is formed by the second machine segment. To form the respective stop partner, the transmission element and/or the second machine segment can have a recess, a pin or similar design. The stop partners of the first stop are in particular closer to the segment pivot axis than the actuator transmission pivot axis and/or the transmission segment pivot axis. In a further preferred embodiment of the invention, the second stop partner of the first stop is formed by a bolt element which extends through the two machine segments along the segment pivot axis to achieve the pivoting mobility of the second machine segment relative to the first machine segment. In this way, the structure of the machine according to the invention is further simplified.

Preferably, the pivot limiting device is designed to limit the pivoting mobility of the transmission element about the actuator transmission pivot axis in such a way that the position of the transmission segment pivot axis relative to the actuator pivot plane is at least phase-wise constant when the second machine segment pivots about the segment pivot axis. This applies at least to part of the pivoting of the second machine segment from the segment working position to the segment transport position, in particular to a second phase which follows the first phase from the center position and extends to the segment transport position. During this second phase, the transmission element is arranged in particular in a fixed position relative to an end of the actuator facing the transmission element. The constant position of the transmission segment pivot axis relative to the actuator pivot plane preferably means a constant distance, wherein the transmission segment pivot axis is in particular located on the same side of the actuator pivot plane as in the first phase. Particularly preferably, the position of the transmission segment pivot axis relative to the actuator pivot plane is constant in that the transmission segment pivot axis is arranged in the actuator pivot plane. The described constant positioning of the transmission element with the transmission segment pivot axis avoids overhang and thus a larger space requirement of the transmission element, especially in the second phase.

Preferably, the pivot limiting device has a second stop. The first stop has a first stop partner and a second stop partner and is designed such that the stop partners come into contact during rotation of the second machine segment from the segment working position to the segment transport position, to limit the pivoting mobility of the transmission element about the actuator transmission pivot axis in a first pivoting direction. Preferably, the stop partners of the second stop come into contact in the center position. The second stop, in particular since the first stop no longer limits the pivoting mobility of the transmission element, achieves a fixation of the actuator segment pivot axis, the actuator transmission pivot axis and the transmission segment pivot axis to one another. Particularly preferably, the first stop partner of the second stop is formed by a stop element which is arranged in a fixed position relative to the part of the actuator facing the transmission element. Alternatively or additionally, the second stop partner of the second stop is formed by the transmission element. The second stop partner of the second stop and/or the second stop partner of the first stop are preferably formed in detail by a pin or peg protruding in a direction parallel to the axes. This further simplifies the structure of the transfer device.

The pivot limiting device preferably has a third stop. The third stop has a first stop partner and a second stop partner. The third stop is to be designed or configured in such a way that the stop partners come into contact when the second machine segment is pivoted from the segment working position into the segment transport position in order to limit the pivoting mobility of the transmission element about the actuator transmission pivot axis in a second pivoting direction which is opposite to the first pivoting direction. The pivot limiting device is designed in particular such that the stop partners of the third stop come into contact while the second machine segment is arranged between the center position and the segment transport position, i.e. is in the second phase. The third stop, particularly in combination with the second stop, selectively prevents any pivoting of the transmission element relative to the actuator after the first stop no longer acts. This ensures complete stabilization of the transmission element in its space-saving position, in particular also in the case of a compressive force between the actuator segment pivot axis and the transmission segment pivot axis.

Preferably, the first stop partner of the third stop is formed by a stop element which is arranged in a fixed position relative to a/the part of the actuator facing the transmission element. Alternatively or additionally, the second stop partner of the third stop is preferably formed by a pawl element. The pawl element is mounted on the transmission element, in particular at least partially between the actuator transmission pivot axis and the transmission segment pivot axis, so that it can be transferred from a release position into a stop position. The pawl element is particularly preferably mounted so as to be pivotable about a pawl pivot axis relative to the transmission element. The transferability of the pawl element also enables both the achievement and the fixing of the position of the transmission element relative to the actuator in a structurally simple manner, which it holds in particular when the stop partners of the first stop are released from each other.

The pivot limiting device preferably has at least one first pawl actuating element which is designed to transfer the pawl element from the release position into the stop position. Alternatively or additionally, the pivot limiting device has at least one second pawl actuating element which is designed to transfer the pawl element from the stop position into the release position. The at least one pawl actuating element reliably ensures the at least one intended function of the pawl element.

Preferably, the first pawl actuating element and/or the second pawl actuating element are/is arranged in a fixed position relative to the second machine segment. In particular, the first pawl actuating element and/or the second pawl actuating element are/is rigidly arranged on the second machine segment. In this case, the transfer of the pawl element is generated solely by the pivoting of the second machine segment relative to the transmission element about the transmission segment pivot axis.

The second pawl actuating element is designed in particular as a further pin or peg. The first pawl actuating element preferably forms a blocking surface facing away from the transmission segment pivot axis, which blocking surface has at least substantially a constant distance from the transmission segment pivot axis. The blocking surface is in particular a surface along which the pawl element slides at least in phases, at least during the pivoting of the second machine segment from the segment working position into the segment transport position. As a result, the pawl element can be reliably held in the stop position, in particular at least in part of the second phase, in which it fixes the transmission element relative to the part of the actuator facing the transmission element. During the first phase, the second pawl actuator positions the pawl element in the release position.

Further details and advantages of the invention can be seen from the schematically illustrated figures described below; in particular:

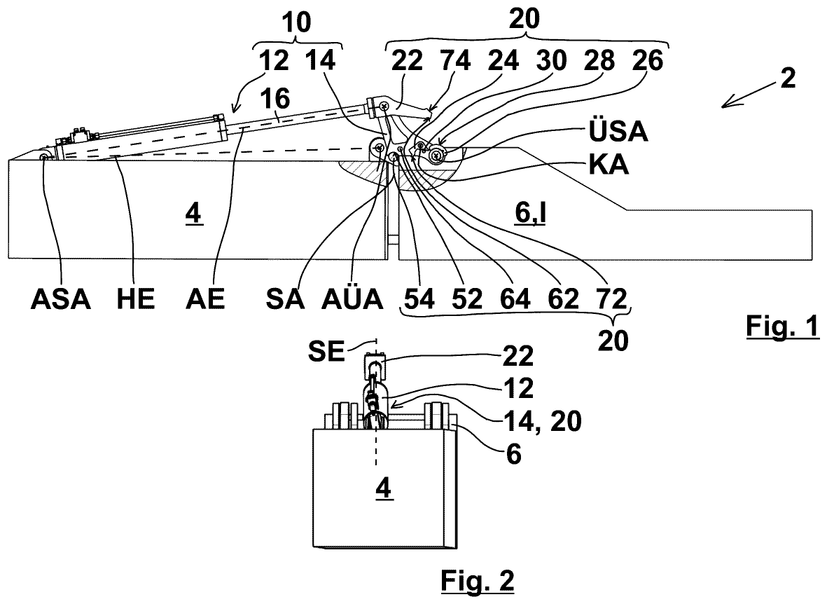

FIG. 1 shows a partial sectional view of a first machine according to the invention in a segment transport position,

FIG. 2 shows a side view of the machine according to FIG. 1,

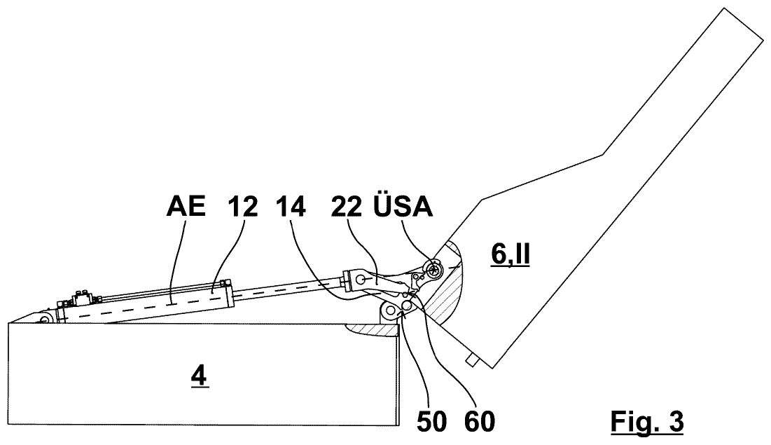

FIG. 3 shows a partial sectional view of the machine according to FIG. 1 in a center position,

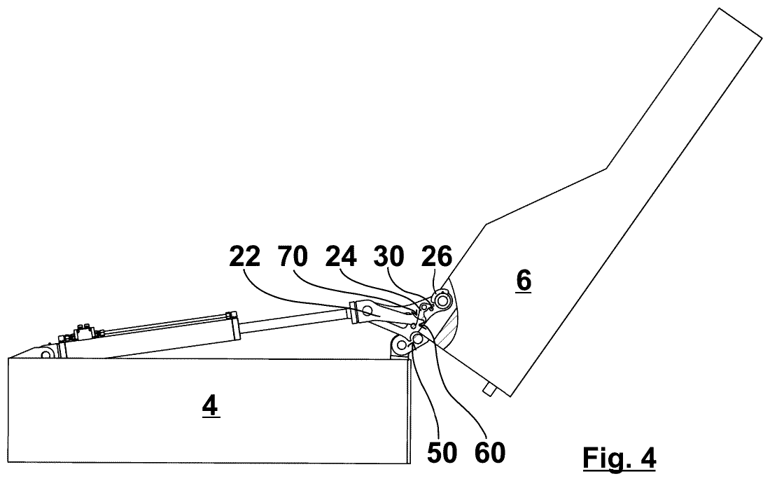

FIG. 4 shows a partial sectional view of the machine according to FIG. 1 in a first position between the center position and a segment transport position,

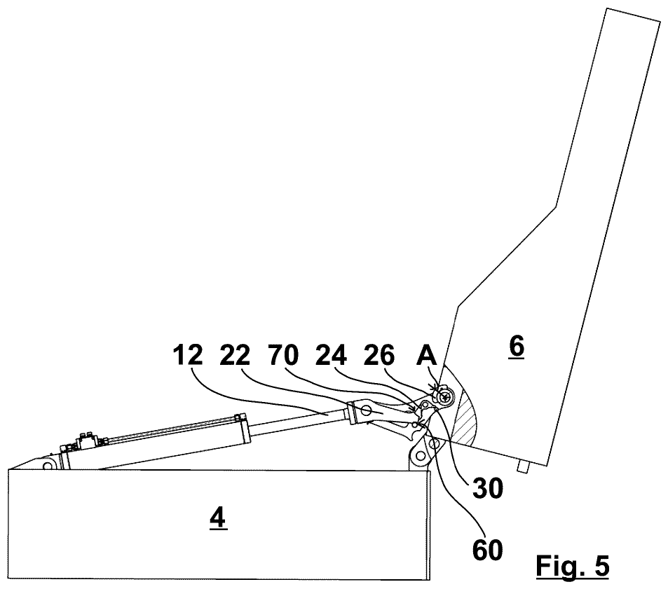

FIG. 5 shows a partial sectional view of the machine according to FIG. 1 in a second position between the center position and a segment transport position,

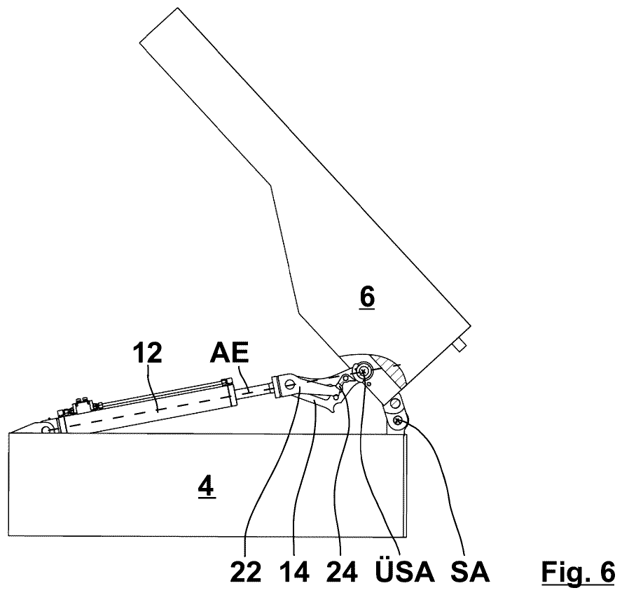

FIG. 6 shows a partial sectional view of the machine according to FIG. 1 in a third position between the center position and a segment transport position,

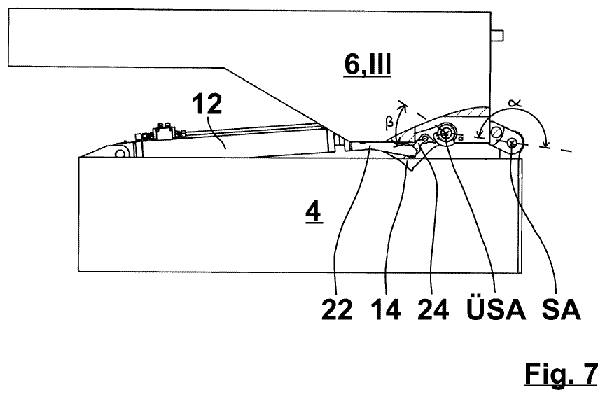

FIG. 7 shows a partial sectional view of the machine according to FIG. 1 in the segment transport position,

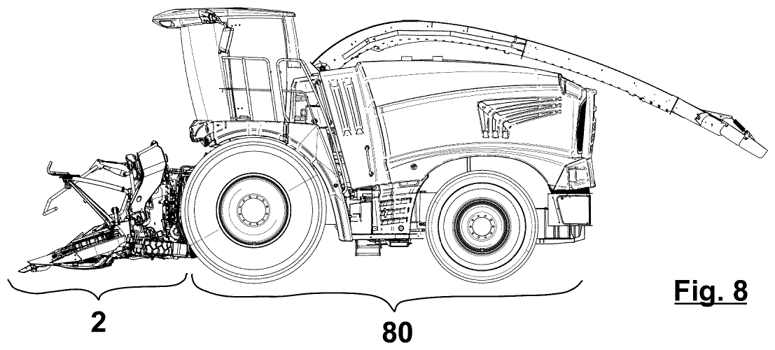

FIG. 8 shows a side view of a forage harvester with a second machine according to the invention in the segment working position,

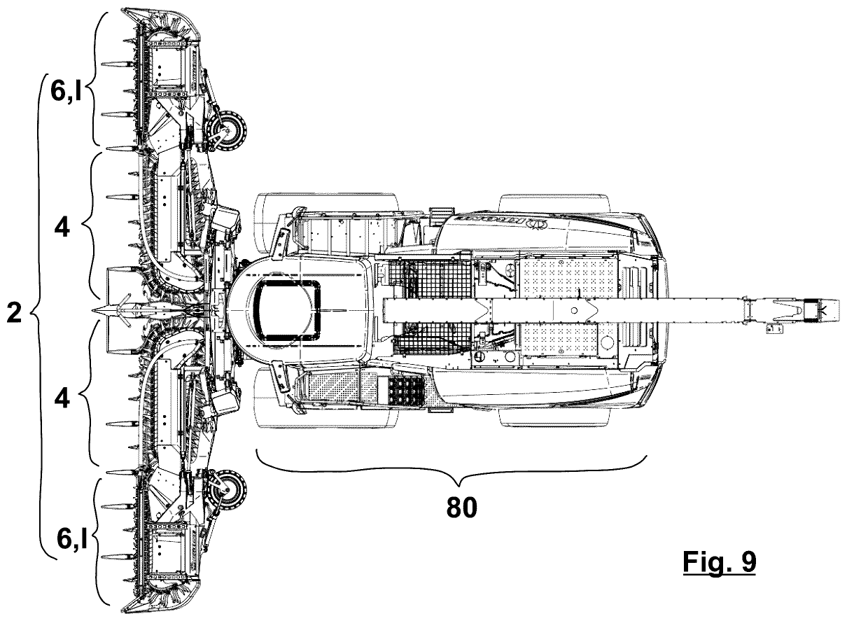

FIG. 9 shows a plan view of the forage harvester and the second machine according to FIG. 8,

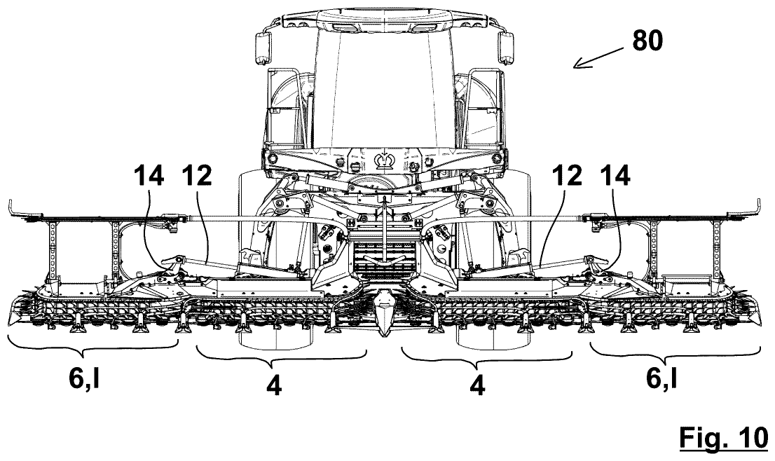

FIG. 10 shows a front view of the forage harvester and the second machine according to FIG. 8,

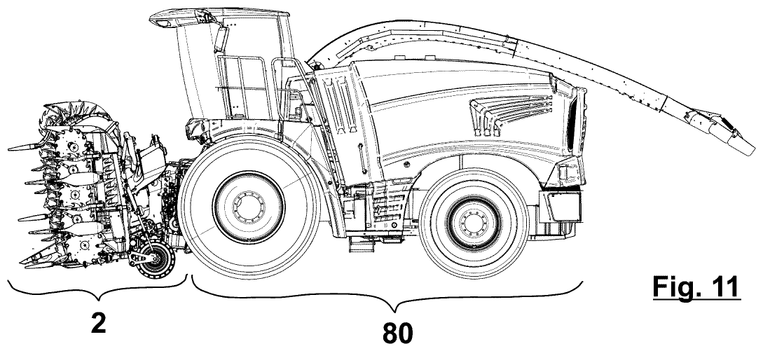

FIG. 11 shows a side view of the forage harvester and the second machine according to the invention in the segment transport position,

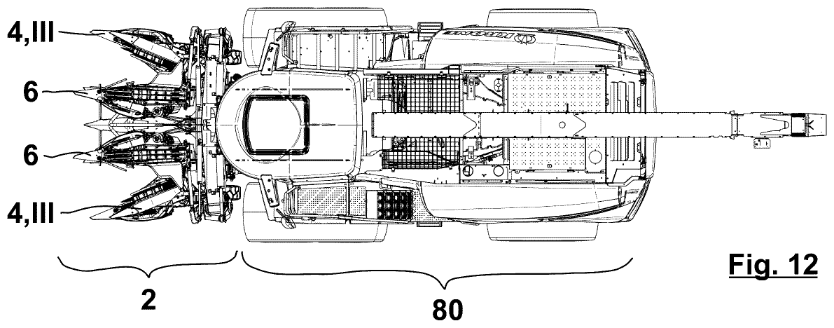

FIG. 12 shows a plan view of the forage harvester and the second machine according to FIG. 11,

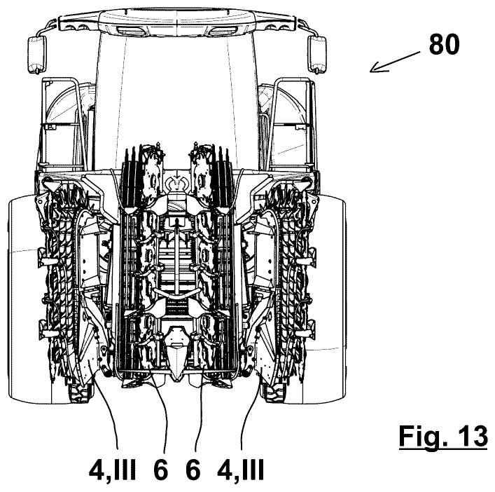

FIG. 13 shows a front view of the forage harvester and the second machine according to FIG. 11.

Identical or similarly acting components of the machine according to the invention are selectively provided with the same reference numerals in the figures. Further developments according to the invention also result from other combinations of the described features than those shown.

FIGS. 1 to 7 show a first agricultural machine 2. The agricultural machine 2 has a first machine segment 4 and a second machine segment 6. The machine segments 4, 6 are shown in a highly simplified manner. FIGS. 1 and 3 to 7 illustrate a transfer of the machine 2 with the second machine segment 6 from a segment working position I via a center position II to a segment transport position III.

The second machine segment 6 is mounted so that it can pivot relative to the first machine segment 4 about a segment pivot axis SA. A transfer device 10 is used to pivot the second machine segment 6 about the segment pivot axis SA. The transfer device 10 comprises an actuator 12 which is arranged to be pivotable relative to the first machine segment 4 about an actuator segment pivot axis ASA. Furthermore, the transfer device 10 comprises a transmission element 14 which is pivotably mounted on the actuator about an actuator transmission pivot axis AÜA spaced from the segment pivot axis SA. In addition, the transmission element 14 is pivotably mounted about a transmission segment pivot axis USA on the second machine segment 6. The actuator segment pivot axis ASA and the actuator transmission pivot axis AÜA lie in an actuator pivot plane AE. The actuator segment pivot axis ASA and the segment pivot axis SA lie in an auxiliary plane HE. A section plane SE, along which the machine 2 is partially sectioned in FIGS. 1 and 3 to 7, is illustrated in FIG. 2.

The transfer device 10 has a pivot limiting device 20. The pivot limiting device 20 comprises a stop element 22 which is arranged in a fixed position relative to the part 16 of the actuator 12 facing the transmission element 14. Furthermore, the pivot limiting device 20 comprises a pawl element 24 which is arranged on the transmission element 14 so as to be pivotable about a pawl pivot axis KA. For moving the pawl element 24, the pivot limiting device 20 comprises a first pawl actuating element 26, which is arranged stationary relative to the second machine segment 6 and forms a blocking surface 26 facing away from the transmission segment pivot axis ÜSA, the distance A of which (see FIG. 5) from the transmission segment pivot axis ÜSA is uniform. In addition, the pivot limiting device 20 for pivoting the pawl element 24 comprises a second pawl actuating element 30 which, like the first pawl actuating element 26, is arranged stationary relative to the second machine segment 6. Among other things, the aforementioned components of the pivot limiting device 20 form a first stop 50, a second stop 60 and a third stop 70, each of which comprises two stop partners 52 and 54, 62 and 64 or 72 and 74, and whose function is described in detail below.

In the segment working position I of the second machine segment 6, the transmission segment pivot axis ÜSA is arranged below the auxiliary plane HE. In order to be able to use a force acting from the actuator segment pivot axis ASA and generated by the actuator 12 to pivot the second machine segment 6 upwards from the segment working position I, it is deflected in a first phase via the actuator transmission pivot axis AÜA. To enable the deflection, the first stop partner 52 and the second stop partner 54 of the first stop 50 lie against each other in the region between the segment pivot axis SA and the transmission segment pivot axis ÜSA (FIG. 1).

After a first upward pivoting of the second machine segment 6 from the segment working position I, i.e. the first phase, the machine segment 6 reaches a center position II. The center position II is characterized by the fact that the transmission segment pivot axis ÜSA is moved into the actuator pivot plane AE, whereby the actuator segment pivot axis ASA, the actuator transmission pivot axis AÜA and the transmission segment pivot axis ÜSA lie on one line (actuator pivot plane AE) in the illustration according to FIG. 3. Up to the center position II, the stop partners 52, 54 of the first stop 50 lie continuously against each other. The separation of the stop partners 52, 54 releases the pivoting mobility of the transmission element 14 relative to the second machine segment 6. In the center position II, the stop partners 62, 64 of the second stop 60 abut one another. As a result, starting from the center position II and thus during a second phase beginning in the center position II, a further pivoting of the transmission element 14 relative to the actuator 12 and, in the perspective according to FIG. 3, in a counterclockwise direction, is prevented.

FIG. 4 to 6 illustrate further positions of the second machine segment 6 relative to the first machine segment 4, which follow the center position II during the second phase of pivoting from the segment working position I to the segment transport position III. It is clear that the stop partners 52, 54 of the first stop 50 are spaced apart from each other as the second machine segment is pivoted beyond the center position II. It is also clear that the stop partners 62, 64 of the second stop 60 remain in contact with each other and maintain their described purpose.

FIGS. 3 to 6 also illustrate a pivoting of the pawl element 24 by the first pawl actuating element 26 from a release position i (see FIG. 3) into a stop position ii (see FIG. 6). In the stop position ii, the pawl element 24 rests against the blocking surface 28 of the first pawl actuating element 26. In the stop position ii, the first stop partner 72 of the third stop 70 formed by the pawl element is in contact with the second stop partner 74 of the third stop 70 formed by the stop element 22, after the stop element 22 and the pawl element 24 have previously moved along one another in the release position i (see FIGS. 1 and 3). Thus, a relative movement between the part 16 of the actuator 12 and the transmission element 14 is reliably prevented even if the center of gravity of the second machine segment 6 lies on the same side of the segment pivot axis SA as the center of gravity of the first machine segment 4 (FIG. 6). The second pawl actuating element 30 serves to pivot the pawl element 24 back from the stop position ii into the release position i during the pivoting back of the second machine segment 6 from the segment transport position III into the segment working position I, as can be seen in detail in FIG. 5.

FIG. 7 shows the machine 2 with the second machine segment 6 in the segment transport position III. The transmission segment pivot axis ÜSA remains in the actuator pivot plane AE. As FIG. 7 clearly illustrates, a particularly compact form of the transfer device 10 is thus achieved. Of great relevance here is that a first angle α, by which the second machine segment 6 was pivoted from the segment working position I into the segment transport position II relative to the first machine segment 4, considerably exceeds a second angle β, by which the transmission element 14 was pivoted for pivoting the second machine segment 6 from the segment working position I into the segment transport position III relative to the first machine segment 4. As a result, in particular the space below the transmission segment pivot axis ÜSA, which was still required according to the prior art and into which the transmission element 14 had to be immersed in the segment transport position III, is no longer required.

FIGS. 8 to 13 each show a forage harvester 80 to which a second agricultural machine 2 according to the invention is coupled. This machine 2 comprises two first machine segments 4 and two second machine segments 6 (see FIGS. 9, 10, 12, 13). In the segment working position I according to FIGS. 8 to 10, the second machine segments 6 extend laterally next to the first machine segments 4. In the segment transport position III, on the one hand, the second machine segments 6 are pivoted relative to their adjacent first machine segments 4 by 180° from the segment working position I into a segment transport position III. On the other hand, the first two machine segments 4 are pivoted by 180° relative to each other.

### List of Reference Numerals

2 agricultural machine

4 first machine segment

6 second machine segment

10 transfer device

12 actuator

14 transmission element

16 part of the actuator

20 pivot limiting device

22 stop element

24 pawl element

26 first pawl actuating element

28 blocking surface

30 second pawl actuating element

50 first stop

52 first stop partner of the first stop

54 second stop partner of the first stop

60 second stop

62 first stop partner of the second stop

64 second stop partner of the second stop

70 third stop

72 first stop partner of the third stop

74 second stop partner of the third stop

80 forage harvester

I segment working position

II segment center position

III segment transport position

i release position

stop position

A distance

ASA actuator segment pivot axis

AE actuator pivot plane

AÜA actuator transmission pivot axis

HE auxiliary plane

KA pawl pivot axis

SA segment pivot axis

SE section plane

ÜSA transmission segment pivot axis

α pivot angle of the second machine segment

β pivot angle of the transmission element

1. An agricultural machine (2) comprising
a first machine segment (4),
a second machine segment (6) which is mounted so that it can pivot relative to the first machine segment (4) about a segment pivot axis (SA),
and a transfer device (10),
which is designed to pivot the second machine segment (6) about the segment pivot axis (SA) from a segment working position (I) into a segment transport position (III),
which has at least one actuator (12) arranged pivotably about an actuator segment pivot axis (ASA) relative to the first machine segment (4) and
which has at least one transmission element (14) that is pivotably mounted on the actuator (12) about an actuator transmission pivot axis (AÜA), which is at a distance from the segment pivot axis (SA), is arranged with the actuator segment pivot axis (ASA) in an actuator pivot plane (AE) and is arranged on the second machine segment (6), characterized in that the transmission element (14) is mounted on the second machine segment (6) so as to be pivotable about a transmission segment pivot axis (ÜSA), and the transfer device (10) comprises a pivot limiting device (20) which is designed to limit the pivoting mobility of the transfer element (14) about the transfer segment pivot axis (ÜSA) in such a way that the transfer segment pivot axis (ÜSA) is spaced apart from the actuator pivot plane (AE).

2. The machine according to claim 1, characterized in that the pivot limiting device (20) is designed to limit the pivoting mobility of the transmission element (14) about the transmission segment pivot axis (ÜSA) depending on a pivoting position of the second machine segment (6) relative to the first machine segment (4).

3. The machine according to claim 1, characterized in that the pivot limiting device (20) is designed to limit the pivoting mobility of the transmission element (14) about the transmission segment pivot axis (ÜSA) in such a way that a first angle (α) by which the second machine segment (6) pivots from the segment working position (I) to the segment transport position (III) relative to the first machine segment (4) exceeds a second angle (β) by which the transmission element (14) is to be pivoted to pivot the second machine segment (6) from the segment working position (I) into the segment transport position (III) relative to the first machine segment (4).

4. The machine according to claim 1, characterized by a design of the transfer device (10) such that the transfer segment pivot axis (ÜSA) is moved through an auxiliary plane (HE) in which the actuator segment pivot axis (ASA) and the segment pivot axis (SA) lie when the second machine segment (6) is pivoted from the segment working position (I) into the segment transport position (III).

5. The machine according to claim 1, characterized in that the pivot limiting device (20) has a first stop (50) which has a first stop partner (52) and a second stop partner (54) and is designed such that the stop partners (52, 54) are in contact in the segment working position (I) of the second machine segment (6) to limit the pivoting mobility of the transmission element (14) about the actuator transmission pivot axis (AÜA) and are spaced apart from one another when the second machine segment (6) is pivoted from the segment working position (I) into the segment transport position (III).

6. The machine according to claim 1, characterized in that the first stop partner (52) of the first stop (50) is formed by the transmission element (14) and/or the second stop partner (54) of the first stop (50) is formed by the second machine segment (6).

7. The machine according to claim 1, characterized in that the pivot limiting device (20) is designed to limit the pivoting mobility of the transmission element (14) about the actuator transmission pivot axis (AÜA) in such a way that the position of the transmission segment pivot axis (ÜSA) relative to the actuator pivot plane (AE) is at least phase-wise constant during the pivoting of the second machine segment (6) about the segment pivot axis (SA), wherein the transmission segment pivot axis (ÜSA) is arranged in particular in the actuator pivot plane (AE).

8. The machine according to claim 1, characterized in that the pivot limiting device (20) has a second stop (60) which has a first stop partner (62) and a second stop partner (64) and is designed such that the stop partners (62, 64) come in contact during rotation of the second machine segment (6) from the segment working position (I) to the segment transport position (III), to limit the pivoting mobility of the transmission element (14) about the actuator transmission pivot axis (AÜA) in a first pivoting direction (R1).

9. The machine according to claim 1, characterized in that the first stop partner (62) of the second stop (60) is formed by a stop element (22) which is arranged in a fixed position relative to a part (16) of the actuator (12) facing the transmission element (14), and/or the second stop partner (64) of the second stop (60) is formed by the transmission element (14).

10. The machine according to claim 1, characterized in that the pivot limiting device (20) has a third stop (70) which has a first stop partner (72) and a second stop partner (74) and is designed such that the stop partners (72, 74) come into contact during the rotation of the second machine segment (6) from the segment working position (I) to the segment transport position (III) to limit the pivoting mobility of the transmission element (14) about the actuator transmission pivot axis (AÜA) in a second pivoting direction (R2) which is opposite the first pivoting direction (R1).

11. The machine according to claim 1, characterized in that the first stop partner (72) of the third stop (70) is formed by a stop element (22) which is arranged in a stationary manner relative to a part of the actuator (12) facing the transmission element (14), and/or the second stop partner (74) of the third stop (70) is formed by a pawl element (24) which is mounted on the transmission element (14) so as to be transferable from a release position (i) into a stop position (ii), in particular so as to be pivotable about a pawl pivot axis (KA).

12. The machine according to claim 1, characterized in that the pivot limiting device (20) has at least one first pawl actuating element (26) which is designed to transfer the pawl element (24) from the release position (i) into the stop position (ii).

13. The machine according to claim 1, characterized in that the first pawl actuating element (26) forms a blocking surface (28) facing away from the transmission segment pivot axis (ÜSA), which blocking surface (28) has at least substantially a constant distance (A) from the transmission segment pivot axis (ÜSA).

14. The machine according to claim 1, characterized in that the pivot limiting device (20) has at least one second pawl actuating element (30) which is designed to transfer the pawl element (24) from the stop position (ii) into the release position (i).

15. The machine according to claim 1, characterized in that the first pawl actuating element (26) and/or the second pawl actuating element (30) is arranged in a fixed position relative to the second machine segment (6).
